(19) United States
(12) Patent Application Publication
(10) Pub. No.: US 2012/0126051 A1
(43) Pub. Date: May 24, 2012

(54) CUTTING WIRE FOR PLANT-CUTTING EQUIPMENT

(76) Inventor: Emmanuel Legrand, St Germain Sur Renon (FR)

(21) Appl. No.: 13/303,004

(22) Filed: Nov. 22, 2011

(30) Foreign Application Priority Data
Nov. 23, 2010 (FR) 1059640

(51) Int. Cl. B65H 75/18; A01D 34/416; B32B 3/30

(52) U.S. Cl. 242/604; 428/162; 242/118.1

(57) ABSTRACT

The invention concerns a cutting wire (1) for plant-cutting equipment, such as an edger or a brush cutter, the wire (1) being profiled and adapted to be coiled on itself so as to form a reel (B) comprising at least two turns S),

characterised in that the wire (1) comprises reciprocal holding arrangements (10, 20) so that each turn (S) cooperates with at least one adjacent turn (S) so as to hold it mechanically, so that the reel (B) is self-supporting.

The present invention concerns in general terms cutting wires adapted for being used in plant-cutting equipment, in particular edgers or brush cutters.

These wires are generally produced by extruding polyamide, and have varied shapes.

Whereas the oldest wires had a circular cross section and were smooth over their entire extent, wires having varied cross sections have been developed, in order to improve the cutting quality (presence of ridges, etc) and or the longevity of the wire, and/or reducing the noise of the equipment in operation by acting on turbulence.

There are thus wires having ridges, grooves, furrows or local deformations of the wire along the extent thereof, generally produced by drawing/extrusion of polyamide.

For reasons of economy of space, the cutting wires are stored and sold in the form of reels. However, the rigidity of the materials making them up means that they cannot by themselves remain in the form of reels and automatically come undone if they are not retained by any holding means.

Typically, the cutting wire coils are sold in packages with a shape and dimensions adjusted to the shape and dimensions of the reel, so that the latter is held in shape by the internal walls of the box. The manufacture of these boxes does however have an economic and ecological cost.

The invention therefore aims to propose a cutting wire for plant-cutting equipment that can be stored, transported and sold without any particular packaging, so as to reduce the environmental impact of the product and to reduce costs.

To this end, according to a first aspect, the invention proposes a cutting wire for plant-cutting equipment, such as an edger or brush cutter, the wire being profiled and adapted in order to be coiled on itself so as to form a reel comprising at least two turns, the wire comprising reciprocal holding arrangements so that each turn cooperates with at least one adjacent turn so as to hold it mechanically, so that the reel is self-supporting.

Some preferred but non-limitative aspects of the wire are as follows:
two adjacent turns fit together by elastic deformation of the holding arrangements;
the holding arrangements cooperate by friction,
the holding arrangements comprises a male element and a female element extending over two opposite faces of the wire and over all or part of the length thereof, the male element of each turn of the reel being adapted to fit in the female element of an adjacent turn,
the male element and the female element are respectively a rib and a groove,
the rib and the groove have substantially complementary transverse sections;
the rib and the groove have different transverse sections,
the shape or shapes of the transverse sections are chosen from rounded shapes and substantially trapezoidal shapes,
the rib and the groove have substantially parallel opposite faces, the width of the rib being slightly greater than that of the groove,
the rib comprises two branches elastically deformable with respect to each other,
the male element is discontinuous so as to assist the cutting of plants,
the arrangements have a surface finish promoting friction,
the wire is coiled on itself and essentially devoid of any conditioning ensuring holding thereof in this state, and
the cutting wire has printed patterns.

According to a second aspect, the invention proposes a cutting-wire reel for plant-cutting equipment, such as an edger or brush cutter, the wire being profiled and adapted to be coiled on itself so as to form at least two turns, characterised in that the wire comprises reciprocal holding arrangements so that each turn cooperates with at least one adjacent turn so as to hold it mechanically, so that the coil is self-supporting.

A preferred but non-limitative aspect of the reel according to the invention is that it has a shape chosen from cylindrical shapes, disc shapes and conical shapes.

According to a last aspect, the invention proposes a dispenser comprising a set of reels according to the invention stacked on one another.

Other features, aims and advantages of the present invention will emerge more clearly from a reading of the following detailed description with regard to the accompanying drawings given by way of illustrative examples and in which:

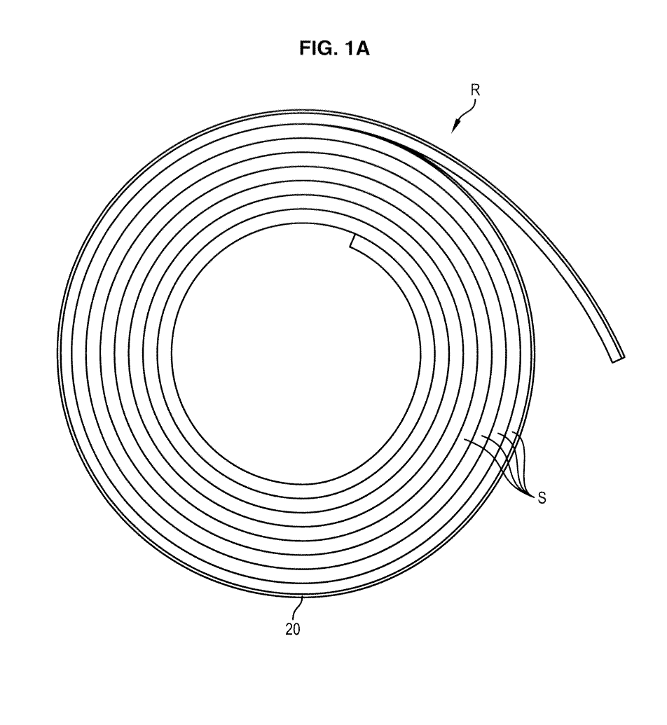

FIG. 1A presents a wire 1 according to the invention coiled on itself so as to form a flat reel;

FIG. 1B present a wire 1 according to the invention coiled on itself so as to form a cylindrical reel;

FIG. 1C illustrates a dispenser for flat reels in accordance with FIG. 1 according to the invention;

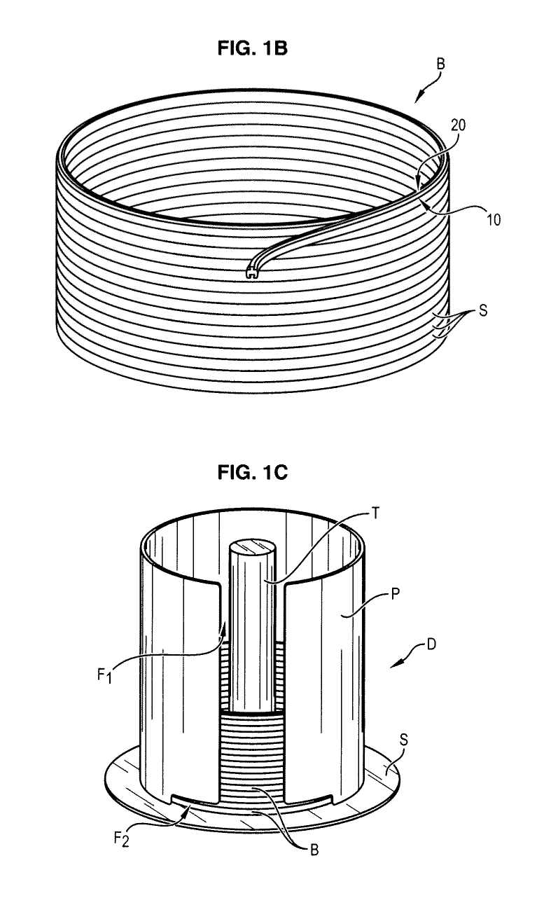

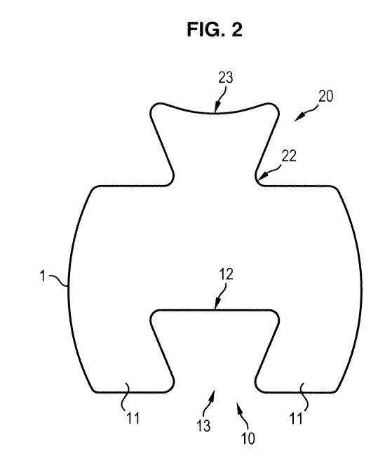

FIG. 2 shows a view in section of a first embodiment of a cutting wire for a flat reel according to the invention;

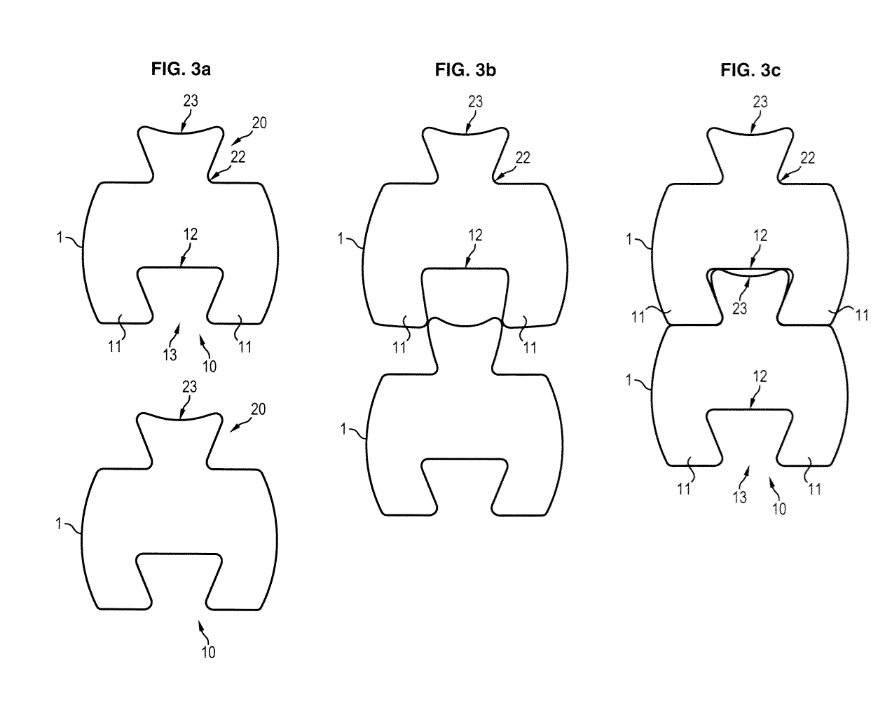

FIGS. 3a, 3b and 3c show the steps of cooperation of two turns of a wire in accordance with FIG. 2, seen in section;

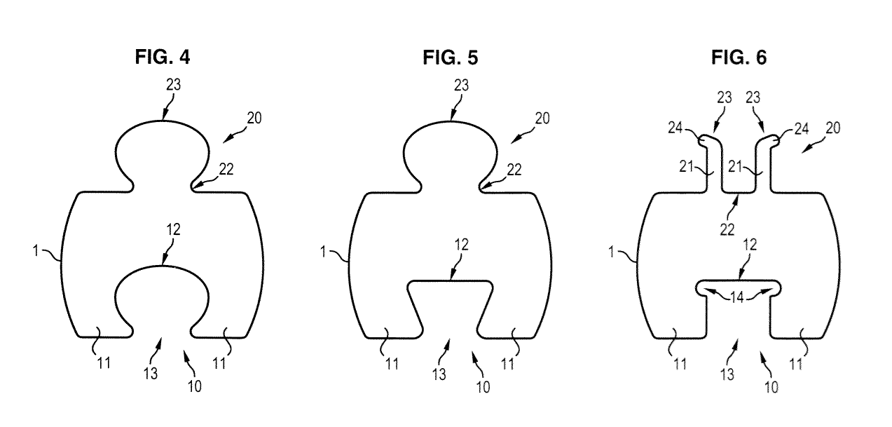

FIG. 4 shows a first variant of the embodiment in FIG. 2 according to the invention;

FIG. 5 shows a second variant of the embodiment in FIG. 2 according to the invention; and

FIG. 6 shows a view in section of a second embodiment of a cutting wire according to the invention.

As illustrated in FIGS. 1A and 1B, a cutting wire 1 according to the invention is profiled and adapted in order to be coiled on itself so as to form a self-supporting reel B.

“Self supporting” will mean here that the reel B is capable of remaining coiled on itself, without any holding means external thereto. It is therefore not necessary to lock the turns S of the reel B by a binding surrounding its turns S so as to hold them adjacent, nor by packaging adjusted to the dimensions and format of the reel.

To this end, the wire comprises reciprocal holding arrangements 10, 20 so that each turn S cooperates with at least one adjacent turn S so as to hold it mechanically, so as to make the reel B self supporting.

More precisely, the holding arrangements 10, 20 are adapted to fit together by elastic deformation.

A self-supporting reel B is therefore obtained, the turns of which fit together so as to form a disc (see FIG. 1A) or a cylinder (see FIG. 1B), depending on the location of the holding arrangements 10, 20.

The packaging of the reel B therefore fulfils no more than a commercial role and no longer needs to fulfil the conditions of holding the wire in the coiled state, keeping dimensions, etc. It can therefore be produced with more freedom, or even be simplified or eliminated.

With reference to FIG. 1C, the flat reels B can for example be stored in a reel dispenser D, such as the one shown in FIG. 1C. Such a dispenser D comprises here a lateral wall P that is substantially cylindrical of revolution and has a longitudinal slot F1 parallel to the axis of revolution thereof. The dispenser D can also comprise a base S on which the cylindrical lateral wall P is fixed as well as a central rod T extending perpendicular from the base S. The flat reels B are then fitted on the rod T of the dispenser D through the top part opposite to the base S, and removed either through the top part of the dispenser D or through a transverse opening F2, preferably adjacent to the base S.

It is in particular possible to print technical and/or commercial information such as the make, the specificities of the wire, etc, in particular when the reel B does not have any packaging, directly on the turns S. For this purpose, it is in particular possible to use pad printing.

It is thus possible to reduce the manufacturing costs of the packaging, as well as the environmental impact thereof.

According to a first embodiment, the reciprocal holding arrangements 10, 20 comprise a male element 20 and a female element 10 extending over all or part of the length of the wire 1, the male element 20 being adapted to penetrate the female element 10 when the wire 1 is coiled on itself so as to form a reel B that is substantially flat (FIG. 1A), substantially cylindrical (FIG. 1B) or substantially conical.

Advantageously, the female 10 and male 20 elements are chosen so that the wire can be produced by conventional drawing/extrusion techniques. It is preferentially produced from polyamide, but other materials are of course possible.

For example, the male element may be a rib 20 extending over all or part of the length of the wire, while the female element 10 may be a groove extending so as to match the rib. The rib 20 and the groove 10 preferably extend on opposite longitudinal sides of the wire.

Here the cutting wire 1 is symmetrical with respect to a plane passing through the middle of the rib and groove. This is however, not limitative.

For example, the wire 1 may have a main body the height of which is of the same order of magnitude as the width, comprising a first lateral face from which the rib 20 extends, and an opposite lateral face in which the groove 10 is produced, the references 11 designating the areas of the material of the wire extending on either side of the groove.

In general terms, the shape and dimensions of the rib 20 are adjusted to the shape and dimensions of the groove 10, so that the rib 20 can fit and be held with a suitable force in the groove 10 of an adjacent turn when the wire 1 is coiled on itself so as to form the reel B.

Preferably, the shape and dimensions of the rib 20 and groove 10 are chosen so that the rib 20 forcibly penetrates the groove 10 in the adjacent turn, with elastic deformation of the wire in the areas 11, when the wire 1 is coiled on itself. In this case, the elastic return of the material of the wire in these areas 11 ensures the holding of the rib 20 and groove 10 once engagement has been effected.

For example, according to an embodiment illustrated in the accompanying FIG. 2, the rib 20 has opposite top and bottom faces 21 that diverge from its base 22 in the direction of its free end 23, while the homologous walls of the groove 10 converge from the base 12 of the groove towards its opening 13. The divergence/convergence angle may vary fairly substantially according to the nature and properties of the material of the wire. It may thus vary from a few degrees to a few tens of degrees. The angles for the rib and for the groove may also be different. It will be understood that the coefficient of friction of the wire may also have an influence.

The base 22 of the rib 20 is then narrower than its free end 23, while the bottom 12 of the groove is wider than its opening 13.

Moreover, the width of the base 22 of the groove is preferably substantially equal to that of the opening 13 of the groove. In this way, the forcible penetration of the rib 20 in the groove 10 elastically separates the areas 11 of the wire (see FIG. 3b) in order to enable the free end of the rib 20 to pass as far as the bottom 12 of the groove. Once the rib 20 is inserted in the groove 10, the elastic return of these areas 11 towards the rib 10 holds the latter in place in a close-fitting manner (FIG. 3c).

The width of the bottom 12 of the groove 10 can optionally be slightly greater than that of the free end 23 of the rib 20, in order to create a clearance between them and facilitate any relative movements of the turns in the reel relating to the coiling/uncoiling of the wire.

The divergence/convergence angle may vary fairly substantially according to the nature and properties of the material of the wire. It may thus vary from a few degrees to a few tens of degrees. The angles for the rib and for the groove may also be different. It will be understood that the coefficient of friction may also have an influence.

The free end face 23 of the rib 20 may also be concave in order to facilitate the relative movement of the adjacent turns S.

In an extreme case, there may be a rib and a groove with parallel opposite faces, the width of the rib being slightly greater than that of the groove so as to cause a holding of the turns together mainly or solely by means of the friction caused by the elastic return of the areas 11.

In a variant, and as illustrated in FIG. 4, the rib has a substantially rounded cross section, approximately circular in shape. The groove 10 can then have a corresponding rounded shape.

The general shape of the rib 20 and that of the groove 10 may however be quite different, provided that the rib 20 can be forcibly inserted in the groove 10 and be held therein mechanically when the wire is coiled. As illustrated in FIG. 5, it is possible to provide a substantially rounded rib 20 and a substantially trapezoidal groove, or vice versa.

It will therefore be understood that the invention covers all forms of holding arrangement 10, 20 adapted to cooperate together mechanically in order to hold the turns of the reel in position, preferably by elastic and/or plastic deformation of the arrangements.

According to a second embodiment, and as illustrated in FIG. 6, the rib 20 can comprises two branches 21, inclined with respect to each other or parallel, separated by a space 25. At its free end, each branch has an outward protrusion 24 forming a locking area.

The groove 10 in this case may have substantially parallel opposite walls, terminating in recesses 14, substantially complementary to the protrusion 24, in the vicinity of the bottom of the groove. The width 11 of the groove is substantially equal to the distance between the external faces of the two branches 21.

In this way, when the rib 20 is inserted in the groove 10, the two branches are urged closer together until the protrusions 24 penetrate the complementary recesses 14. In this position, the branches 21 regain their idle position, in which the protrusions 24 enable the rib 20 to be held in the groove 10.

Whatever the embodiment, the wire 1 can be uncoiled by extracting the rib 20 from the groove 10. To this end, it suffices to pull with the fingers on the free end of the wire 1 so that the rib 20 causes the lateral walls 11 of the groove 10 to separate and, where applicable, so that the branches 21 of the rib 20 are urged closer together.

It will also be understood that, in addition to being able to be coiled so as to form a self-supporting reel B, a cutting wire 1 according to the invention has good cutting qualities given the presence of the male and female 10 elements, which create longitudinal ridges that are sharper than in the case of a solid cutting body with rounded ridges.

In order to improve the quality of the cutting, the wire 1 may also comprises ridges or other supplementary shapes so long as these do not prevent the male 20 and female 10 elements fitting together elastically. It may for example be a case of a local deformation, a longitudinal ridge extending over a lateral side of the wire, etc.

The cutting wire may also comprise roughnesses at the rib and/or groove in order to amplify the rubbing and increase the mechanical holding of the adjacent turns S.

Moreover, although the rib and groove are here described as extending continuously over the extent of the wire, it is possible to provide a furrow and/or groove extending in an interrupted fashion, in particular in order to form, in use, arrangements of the teeth type or the like assisting the cutting of the plants.

Finally, according to the geometry of the wire and in particular the position of the groove and rib, it is possible to provide for the coiling of the wire on itself to give a disc shape or a cylinder shape, but also any intermediate conical shape.

1. Cutting wire for plant-cutting equipment, such as an edger or a brush cutter, the wire being profiled and adapted to be coiled on itself so as to form a reel comprising at least two turns, wherein the wire comprises reciprocal holding arrangements so that each turn cooperates with at least one adjacent turn so as to hold it mechanically, so that the reel is self-supporting.

2. Cutting wire according to claim 1, in which two adjacent turns fit together by elastic deformation of the holding arrangements.

3. Cutting wire according to claim 1, in which the holding arrangements cooperate by friction.

4. Cutting wire according to claim 1, in which the holding arrangements comprise a male element and a female element extending on opposite faces of the wire and over all or part of the length thereof, the male element of each turn of the reel being adapted to fit in the female element of an adjacent turn.

5. Cutting wire according to claim 4, in which the male element and the female element are respectively rib and a groove.

6. Cutting wire according to claim 5, in which the rib and groove have substantially complementary transverse sections.

7. Cutting wire according to claim 5, in which the rib and groove have different transverse sections.

8. Cutting wire according to claim 5, in which the shape or shapes of the transverse sections are chosen from rounded shapes and substantially trapezoidal shapes.

9. Cutting wire according to claim 5, in which the rib and groove have substantially parallel opposite faces, the width of the rib being slightly greater than that of the groove.

10. Cutting wire according to claim 5, in which the rib comprises two branches elastically deformable with respect to each other.

11. Cutting wire according to claim 4, in which the male element is discontinuous so as to assist the cutting of plants.

12. Cutting wire according to claim 1, in which the arrangements have a surface finish promoting friction.

13. Cutting wire according to claim 1, coiled on itself and essentially devoid of any packaging ensuring maintenance thereof in this state.

14. Cutting wire according to claim 13, characterised in that it has printed patterns.

15. Reel of cutting wire for plant-cutting equipment, such as an edger or brush cutter, the wire being profiled and adapted to be coiled on itself so as to form at least two turns wherein the wire comprises reciprocal holding arrangements so that each turn cooperates with at least one adjacent turn so as to hold it mechanically, so that the reel is self-supporting.

16. Reel according to claim 15, which has a shape chosen from cylindrical shapes, disc shapes and conical shapes.

17. Dispenser, characterised in that it comprises a set of reels according to claim 16 stacked on one another.
